(19) United States
(12) Patent Application Publication
(10) Pub. No.: US 2012/0249398 A1
(43) Pub. Date: Oct. 4, 2012

(54) PORTABLE TERMINAL APPARATUS, PROGRAM, AND DISPLAY METHOD

(75) Inventors: Atsuhiko KANDA, Osaka (JP); Hayato TAKENOUCHI, Osaka (JP)

(73) Assignee: KYOCERA CORPORATION, Kyoto (JP)

(21) Appl. No.: 13/430,354

(22) Filed: Mar. 26, 2012

(30) Foreign Application Priority Data
Mar. 28, 2011 (JP) 2011-070426

(51) Int. Cl. G09G 5/00

(52) U.S. Cl. 345/4

(57) ABSTRACT

A portable terminal apparatus includes first and second display sections, first and second detection sections which detect an input to the first and second display sections, respectively, a display control section which controls display of the first and second display sections, and a determination section which determines whether an execution screen is enabled to be displayed on a third display field which is a combination of display fields of the first and second display sections and regarded as a single display field, in a first display mode conforming to the third display field. If it is determined that the execution screen is not enabled to be displayed on the third display field in the first display mode, the display control section displays the execution screen on one of the first and second display fields in a second display mode conforming to the one of the display fields.

### CROSS-REFERENCE TO RELATED APPLICATION

This application claims priority from Japanese Patent Application No. 2011-070426, filed on Mar. 28, 2011, the entire subject matter of which is incorporated herein by reference.

### BACKGROUND OF THE INVENTION

1. Field of the Invention

The present invention relates to a portable terminal apparatus, such as a mobile phone and a PDA (Personal Digital Assistant), a program, and a display method.

2. Description of the Related Art

There has been know a portable terminal apparatus which has two display surfaces. Such a portable terminal apparatus has a function of executing an application program (hereinafter referred to as an “application”) and displaying screens based on the application on a first display surface and a second display surface, respectively, (for example, refer to JP-A-Hei. 9-305262).

In the above configuration, there occurs an occasion where the application is not set such that a screen of the application is displayed in accordance with a display field in which the first display surface and the second display surface are combined. If an attempt is made to display the application screen in such a display field, a problem would arise in the display. For example, details of the screen are not clearly displayed, or the screen comes to the center or an edge of the display field, so that surroundings of the screen become dark or that the screen is displayed in an enlarged manner. For these reasons, even when the display field is enlarged by the two display surfaces, this enlarged display field is not effectively utilized.

### SUMMARY OF THE INVENTION

The present invention has been made in view of the above circumstances, and an aspect of the present invention provides a portable terminal apparatus having a plurality of display sections, which allows a user to effectively use a display field.

According to an illustrative embodiment of the present invention, there is provided a portable terminal apparatus including: a first display section; a second display section; a first cabinet having the first display section; a second cabinet having the second display section; a mechanism section joining the first cabinet to the second cabinet to allow switching between a first state where the first display section is exposed to outside and a second state where the first display section and at least a portion of the second display section are exposed to outside; a first detection section configured to detect an input to the first display section; a second detection section configured to detect an input to the second display section; a display control section configured to control a display of the first display section and a display of the second display section; and a determination section configured to determine whether, in the second state, an execution screen corresponding to an input detected by any one of the first detection section and the second detection section is enabled to be displayed on a third display field in a first display mode conforming to the third display field, the third display field being a combination of a first display field of the first display section and a second display field of the second display section to be regarded as a single display field. If the determination section determines that the execution screen is not enabled to be displayed on the third display field in the first display mode, the display control section is configured to display the execution screen on one of the first and second display fields in a second display mode confirming to the one of the first and second display fields.

In the portable terminal apparatus, the display control section may be configured to display an image representing a predetermined function on the other one of the first and second display fields in addition to displaying the execution screen on the one of the first and second display fields if the determination section determines that the execution screen is not enabled to be displayed on the third display field in the first display mode.

In the portable terminal apparatus, if the determination section determines that the execution screen is not enabled to be displayed on the third displayed field in the first mode, the display control section may be configured to display a confirmation screen to confirm whether to display the execution screen in the second mode. If an input of switching a display field for displaying the execution screen from the third display field into the one of the first and second display fields is detected by any one of the first detection second and the second detection section, the display control section may be configured to display the execution screen on the one of the first and second display fields.

The portable terminal apparatus may further include a storage section. If the input of switching the display field for displaying the execution screen from the third display field to the one of the first and second display fields is detected, the storage section may be configured to store information indicating that the one of the first and second display fields is a display field where the execution screen is displayed in the second display mode.

In the portable terminal apparatus, if the determination section determines that the execution screen is enabled to be displayed in the third display field in the first display mode, the display control section may be configured to display the execution screen on the third display field in the first display mode.

The portable terminal apparatus may further include an execution section configured to execute the function represented by the image. When any one of the first detection section and the second detection section detects an input for selecting the image, the execution section may be configured to execute the function represented by the selected image.

According to another illustrative embodiment of the present invention, there is provided a non-transitory computer readable medium having a computer program stored thereon and readable by a computer of a mobile terminal apparatus including a first display section, a second display section, a first cabinet having the first display section, a second cabinet having the second display section, a mechanism section joining the first cabinet to the second cabinet to allow switching between a first state where the first display section is exposed to outside and a second state where the first display section and at least a portion of the second display section are exposed to outside, a first detection section configured to detect an input to the first display section, and a second detection section configured to detect an input to the second display section, the computer program, when executed by the computer, causing the computer to perform operations including: determining whether, in the second state, an execution screen corresponding to an input detected by any one of the first detection section and the second detection section is enabled to be displayed on a third display field in a first display mode conforming to the third display field, the third display field being a combination of a first display field of the first display section and a second display field of the second display section to be regarded as a single display field; and if it is determined that the execution screen is not enabled to be displayed on the third display field in the first display mode, displaying the execution screen on one of the first and second display fields in a second display mode conforming to the one of the first and second display fields.

According to a further illustrative embodiment of the present invention, there is provided a display method for a mobile terminal apparatus including a first display section, a second display section, a first cabinet having the first display section, a second cabinet having the second display section, a mechanism section joining the first cabinet to the second cabinet to allow switching between a first state where the first display section is exposed to outside and a second state where the first display section and at least a portion of the second display section are exposed to outside, a first detection section configured to detect an input to the first display section, and a second detection section configured to detect an input to the second display section, the display method including: determining whether, in the second state, an execution screen corresponding to an input detected by any one of the first detection section and the second detection section is enabled to be displayed on a third display field in a first display mode conforming to the third display field, the third display field being a combination of a first display field of the first display section and a second display field of the second display section to be regarded as a single display field; and if it is determined that the execution screen is not enabled to be displayed on the third display field in the first display mode, displaying the execution screen on one of the first and second display fields in a second display mode conforming to the one of the first and second display fields.

According to the above configuration, it is possible to provide a portable terminal apparatus having a plurality of display sections, a computer program, and a display method for the portable terminal apparatus having a plurality of display sections and allowing a user to effectively use a display field.

The effect or significance of the present invention will become more apparent by the following explanation of an illustrative embodiment. However, the following illustrative embodiment is just an example when implementing the present invention, and the present invention is not limited to the illustrative embodiment described below at all.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a drawing showing an outer configuration of a mobile phone according to an illustrative embodiment;

FIG. 2 is a view for explaining operation for switching the mobile phone according to the illustrative embodiment;

FIG. 3 is a block diagram showing an overall configuration of the mobile phone according to the illustrative embodiment;

FIGS. 4A to 4C are drawings showing that an operation item screen or a screen A of an application A is displayed on each of display surfaces in the illustrative embodiment;

FIGS. 5A and 5B are drawings showing that the screen A of the application A is displayed in a combined display field in the illustrative embodiment;

FIGS. 6A and 6B are drawings showing that a screen A1 of the application A is displayed on a first display surface and that a widget list screen or the screen A of the application A is displayed on a second display surface, in the illustrative embodiment;

FIGS. 7A and 7B are drawings showing that the screen A of the application A is displayed in the combined display field in the illustrative embodiment;

FIGS. 8A and 8B are drawings showing that the screen A of the application A is displayed on the first display surface and that the widget list screen or the application screen is displayed on the second display surface, in the illustrative embodiment;

FIG. 9 (FIGS. 9A and 9B) is a flow chart showing procedures for displaying the application screen on each of the display surfaces in the illustrative embodiment;

FIG. 10 is a flowchart showing procedures for displaying the application screen on each of the display surfaces in the illustrative embodiment; and

FIGS. 11A and 11B are drawings showing that the screen A of the application A is displayed on the first display surface and that the widget list screen is displayed on the second display surface, in the illustrative embodiment.

### DETAILED DESCRIPTION OF THE INVENTION

Hereinafter, illustrative embodiments of the present invention will be described with reference to the accompanying drawings.

### Configuration of a Mobile Phone

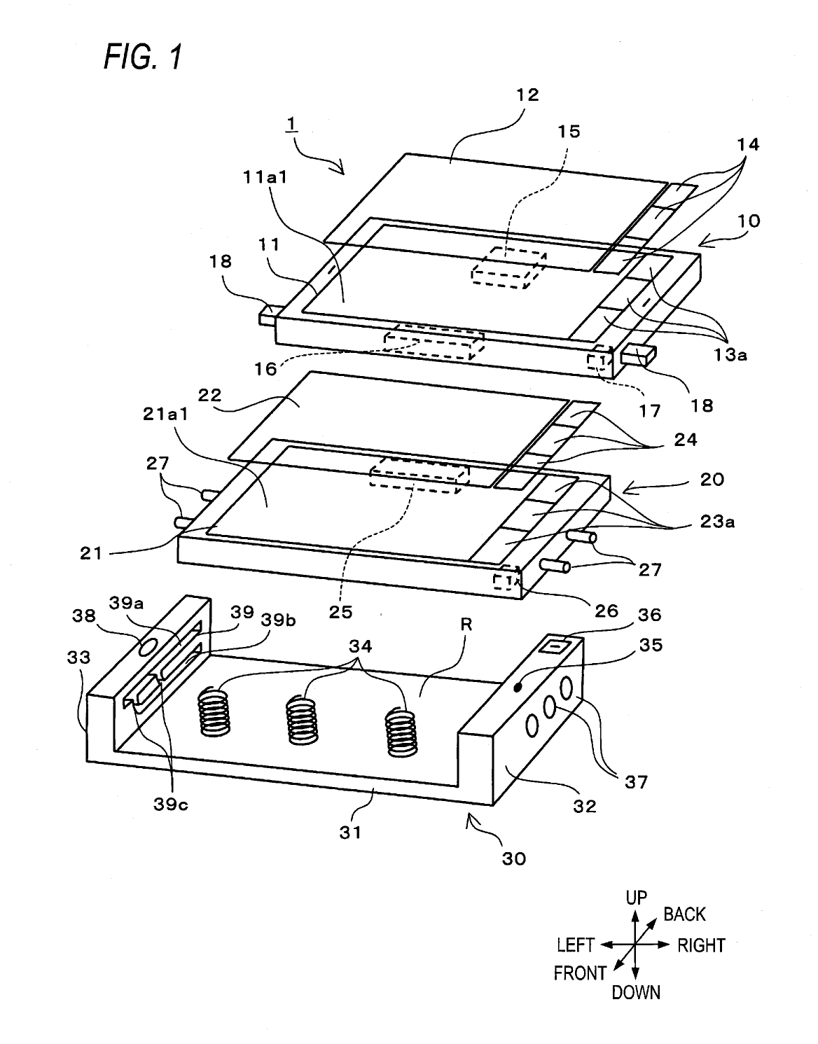

FIG. 1 is an exploded perspective view showing a configuration of a mobile phone 1. The mobile phone 1 includes a first cabinet 10, a second cabinet 20, and a supporting body 30 which supports the first cabinet 10 and the second cabinet 20.

The cabinet 10 has a horizontally long rectangular parallelepiped shape. A first touch panel and a first touch key are arranged on a front surface of the first cabinet 10.

The first touch panel includes a first display 11 and a touch sensor (hereinafter referred to as a “first panel sensor”) 12.

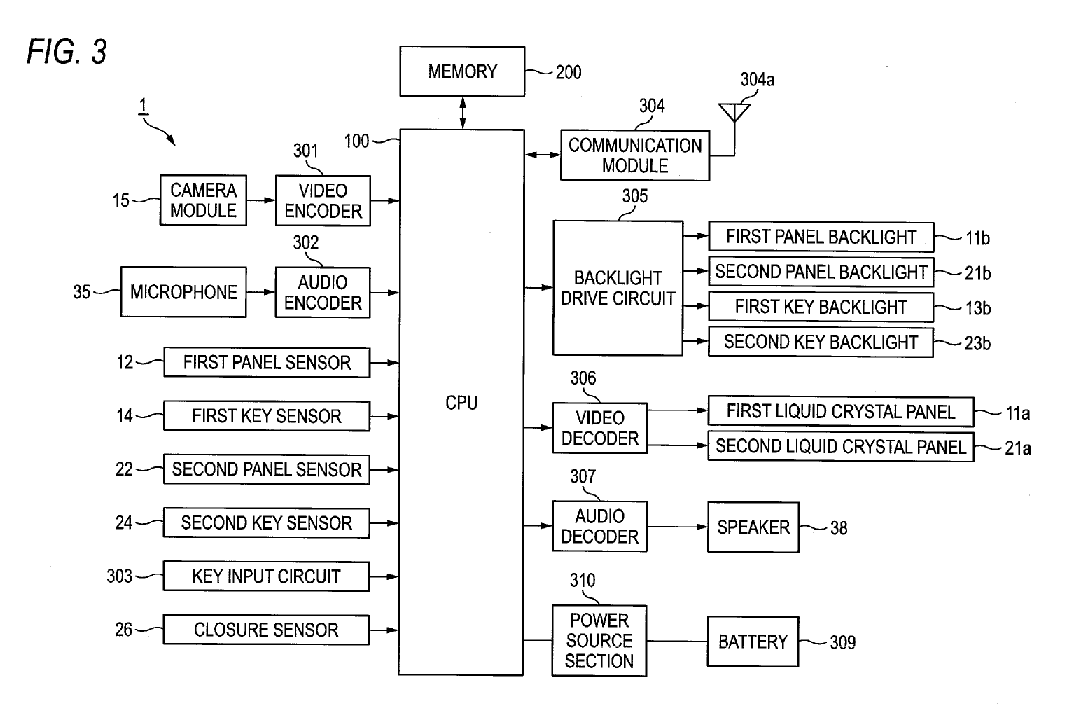

The first display 11 is an example of a display section which displays an image according to a user's operation on a first display surface 11a1. The first display surface 11a1 is an example of a display field of the first display 11. The first display 11 includes a first liquid crystal panel 11a and a backlight (hereinafter referred to as a “first panel backlight”) 11b (see FIG. 3). The first display surface 11a1 is laid over a front surface of the first liquid crystal panel 11a. The first panel backlight 11b includes one or a plurality of light sources and illuminates the first liquid crystal panel 11a.

The first panel sensor 12 is an example of a detection section which detects an input to the first display surface 11a1. The first panel sensor 12 is a transparent, rectangular sheet and covers the first display surface 11a1 of the first display 11. The first panel sensor 12 includes a matrix-arrayed first transparent electrode and a second transparent electrode (not shown). The first panel sensor 12 detects a change in electrostatic capacitance existing among the transparent electrodes, thereby detecting a position on the first display surface 11a1 touched by the user and outputting a position signal corresponding to the input position. Here, the expression “the user touches the first display surface 11a1” means; for example, that the user touches the first display surface 11a1 by means of a contact member, like a pen, and a finger. The contact member or the finger which has touched the first display surface 11a1 can be held stationary or moved by the user. Moreover, a period of time during which the contact member or the finger remains touched on the first display surface 11a1 can also be short or long.

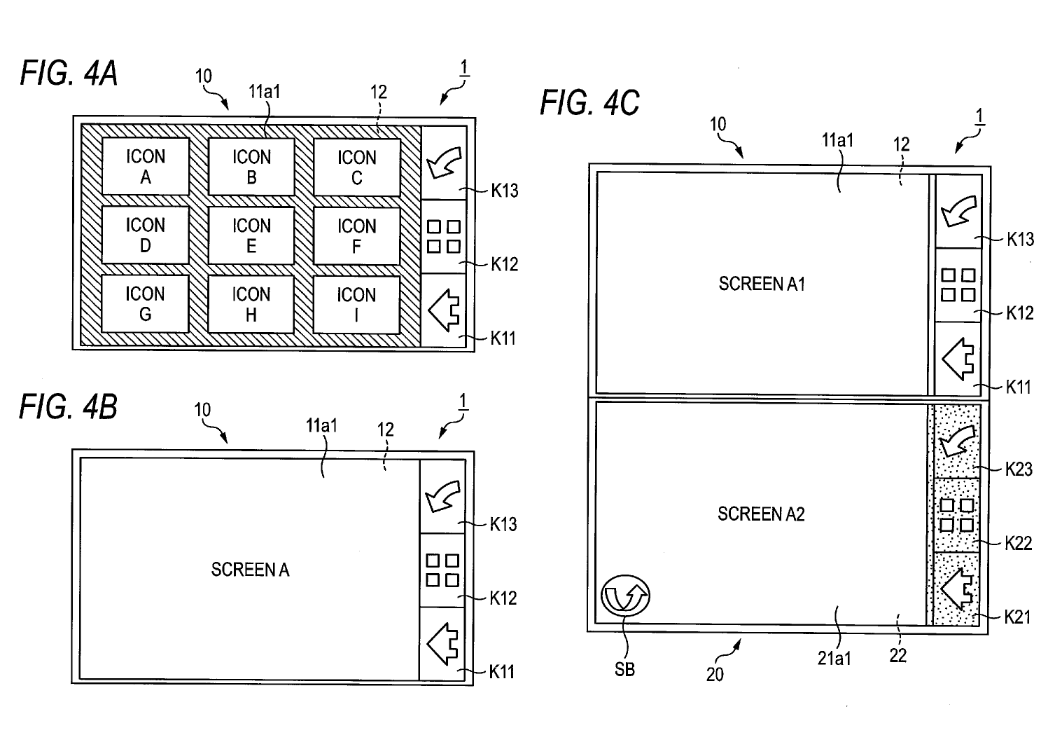

In the present illustrative embodiment, one or a plurality of touch keys; namely, three first touch keys K11, K12, and K13 (see FIG. 4A) are provided adjacently to the first display 11. Each of the first touch keys K11, K12, and K13 is an example of a key section for inputting predetermined information to the first display 11. Each of the first touch keys K11, K12, and K13 includes a panel (hereinafter referred to as a “first key cover”) 13a, a backlight (hereinafter referred to as a “first key backlight”) 13b, and a touch sensor (hereinafter referred to as a “first key sensor”) 14. A predetermined image is displayed on the first key cover 13a.

The first key sensor 14 is an example of a detection section which detects an input to the first key cover 13a. A sensor for sensing a change in electrostatic capacitance is used for the first key sensor 14. Therefore, when the finger or the touch member touches the first key cover 13a of each of the first touch keys K11, K12, and K13, the first key sensor 14 senses a change in electrostatic capacitance, thereupon outputting a detection signal.

A camera module 15 is placed in an interior of the first cabinet 10 at a position slightly closer to a back side with reference to a center of the cabinet 10. A lens aperture (not shown) for capturing a subject image in the camera module 15 is opened in a lower surface of the first cabinet 10.

A magnet 16 is placed at a center position in the vicinity of a front surface within the first cabinet 10, and another magnet 17 is also placed at a right front corner of the interior of the first cabinet 10.

A projection 18 is provided on a right side surface and a left side surface of the first cabinet 10.

The second cabinet 20 has a horizontally long rectangular parallelepiped shape which are substantially the same shape and size as those of the first cabinet 10. A second touch panel and a second touch key are arranged over the second cabinet 20.

The second touch panel includes a second display 21 and a touch sensor (hereinafter referred to as a “second panel sensor”) 22.

The second display 21 is an example of a display section which displays an image according to a user's operation on a second display surface 21a1. The second display surface 21a1 is an example of a display field of the second display 21. The second display 21 includes a second liquid crystal panel 21a and a backlight (hereinafter referred to as a “second panel backlight”) 21b. The second display surface 21a1 is laid over the front surface of the second liquid crystal panel 21a. The second panel backlight 21b includes one or a plurality of light sources and illuminates the second liquid crystal panel 21a. The first display 11 and the second display 21 may also include another display element, like an organic EL.

The second panel sensor 22 is an example of a detection section which detects an input to the second display surface 21a1. The second panel sensor 22 has a shape and a configuration which are similar to those of the first panel sensor 12. The second panel sensor 22 covers the second display surface 21a1 of the second display 21, detects a position on the second display surface 21a1 touched by the user, and outputs a position signal corresponding to the input position.

One or a plurality of second touch keys are provided adjacently to the second display 21. In the present illustrative embodiment, three second touch keys K21, K22, and K23 (see FIG. 4C) are provided adjacently to the second display 21. The second touch keys K21, K22, and K23 are an example of a key section which inputs predetermined information to the second display 21. Each of the second touch keys K21, K22, and K23 includes a panel (hereinafter referred to as a “second key cover”) 23a, a backlight (hereinafter referred to as a “second key backlight”) 23b, and a touch sensor (hereinafter referred to as a “second key sensor”) 24 (see FIG. 3).

The second sensor 24 is an example of a detection section which detects an input to the second key cover 23a. The second key sensor 24 is substantially analogous to the first key sensor 14 in terms of a configuration and a function.

A magnet 25 is placed at a center position in the vicinity of a back surface within the second cabinet 20. The magnet 25 and the magnet 16 of the first cabinet 10 are arranged so as to attract each other in an open state to be described later.

A closure sensor 26 is placed at a right front corner within the second cabinet 20. The closure sensor 26 includes, for example, a Hall IC. Upon detection of magnetic force of the magnet 17, the closure sensor 26 outputs a sensor signal. Since the magnet 17 of the first cabinet 10 approaches the closure sensor 26 in a closed state to be described later, the sensor signal is output from the closure sensor 26 to a CPU 100. In the meantime, since the magnet 17 of the first cabinet 10 moves away from the closure sensor 26 in the open state, the closure sensor 26 does not output a sensor signal.

Two pivots 27 are provided on each side surface of the second cabinet 20, respectively.

The supporting body 30 includes a bottom plate 31, a right supporting body 32 formed on a right end of the bottom plate 31, and a left supporting body 33 formed on a left end of the bottom plate 31.

Three coil springs 34 are arranged in a line along a horizontal direction on the bottom plate 31. In a state where the second cabinet 20 is fitted to the supporting body 30, the coil springs 34 remain in contact with a lower surface of the second cabinet 20, thereby applying upwardly-lifting force to the second cabinet 20.

A microphone 35 and a power key 36 are arranged on an upper surface of the right supporting body 32. A speaker 38 is placed on an upper surface of the left supporting body 33. A plurality of hard keys 37 are provided on an exterior surface of the right holding body 32.

A guide groove 39 (only a guide groove 39 formed on the left supporting body 33 is illustrated) is formed on an interior side surface of the right supporting body 32 and an interior side surface of the left supporting body 33. Each of the guide grooves 39 includes an upper groove 39a, a lower groove 39b, and two vertical grooves 39c. The upper groove 39a and the lower groove 39b extend in a front-back direction, and the vertical grooves 39c vertically extend so as to interconnect the upper groove 39a and the lower groove 39b.

When the mobile phone 1 is assembled, the pivots 27 are inserted respectively into the lower grooves 39b of the guide grooves 39, whereby the second cabinet 20 is held within an accommodation area R of the supporting body 30. The projections 18 are inserted into the upper grooves 39a of the guide grooves 39, whereby the first cabinet 10 is placed on top of the second cabinet 20 and fits into the accommodation area R of the supporting body 30.

The first cabinet 10 and the second cabinet 20 are accommodated, while superimposed one on top of the other, in the accommodation area R enclosed by the bottom plate 31, the right supporting body 32, and the left supporting body 33. In this state, the first cabinet 10 is slidable in a front-back direction along the upper grooves 39a. The second cabinet 20 is slidable in a front-back direction along the lower grooves 39b. Moreover, when the pivots 27 reach the vertical grooves 39c as a result of forward movement of the second cabinet 20, the second cabinet 20 becomes vertically slidable along the vertical grooves 39c.

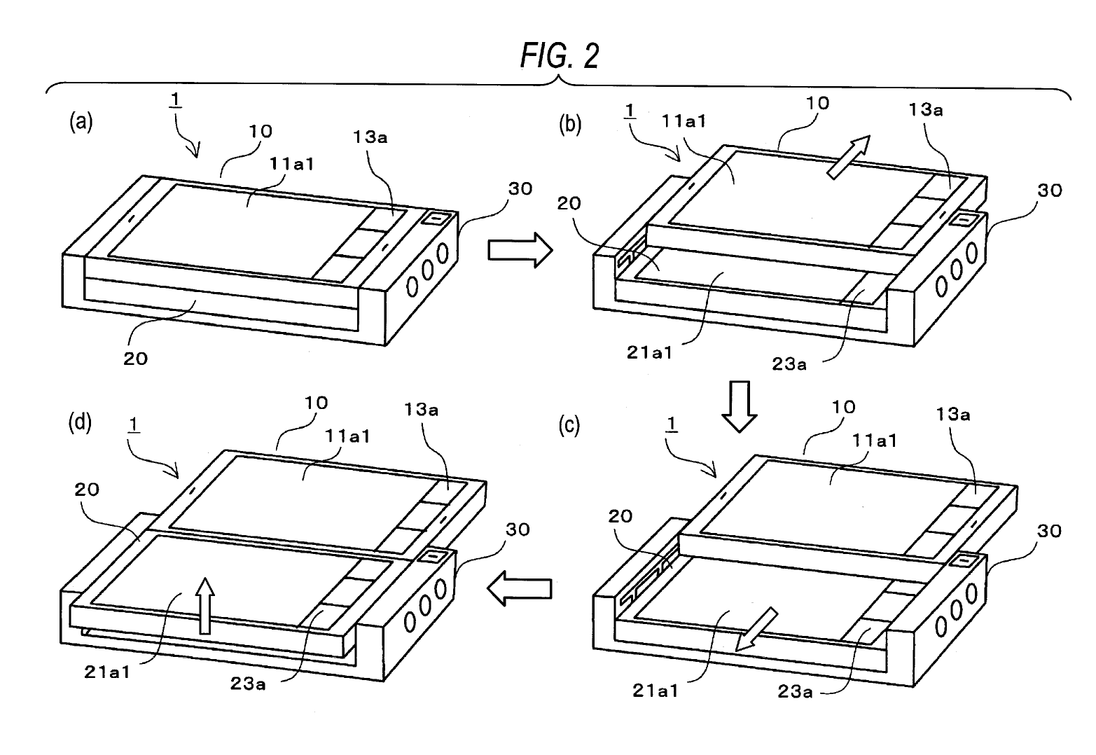

FIGS. 2(a) to 2(d) are views for explaining operation for switching the mobile phone 1 from a closed state to an open state.

In the closed state shown in FIG. 2(a), the first cabinet 10 is superimposed on the second cabinet 20, whereupon the mobile phone 1 is folded. The closed state is an example of a first state where the second display surface 21a1 is covered with the first cabinet 10. In the closed state, only the first display surface 11a1 becomes exposed to outside.

In an arrow-head direction shown in FIG. 2(b), the first cabinet 10 is moved backward, and the second cabinet 20 is withdrawn forwardly along the arrow-head direction shown in FIG. 2(c). When the closure sensor 26 does not detect magnetic force of the magnet 17 and stops outputting a sensor signal, the mobile phone 1 is thereby switched to an open state. In the open state, a portion of the second display surface 21a1 appears outside.

When the first cabinet 10 moves so as not to overlap the second cabinet 20, the pivots 27 shown in FIG. 1 enter the respective vertical grooves 39c. The pivots 27 move along the vertical grooves 39c, thereby rendering the second cabinet 20 vertically movable. The second cabinet 20 is upwardly lifted by resilient force of the coil springs 34 and attractive forces of the magnets 16 and 25.

As shown in FIG. 2(d), the second cabinet 20 and the first cabinet 10 stand side by side while contacting each other, the second display surface 21a1 becomes equal in level to the first display surface 11a1. The first cabinet 10 and the second cabinet 20 are thereby extended, whereupon both the first display surface 11a1 and the second display surface 21a1 become exposed to outside.

As shown in FIGS. 2(b) to 2(d), the open state is an example of a second state where at least a portion of the second display surface 21a1 becomes exposed to outside.

Further, the projections 18 move along the upper grooves 39a of the guide grooves 39, and the pivots 27 move along the lower grooves 39b, the vertical grooves 39c, and the upper grooves 39a, whereby switching takes place between the open state and the closed state. Therefore, the projections 18, the pivots 27, and the guide grooves 39 are an example of a mechanism section which joins the first cabinet 10 to the second cabinet 20 so as to allow switching between the closed state and the open state.

FIG. 3 is a block diagram showing an overall configuration of the mobile phone 1. In addition to the foregoing constituent elements, the mobile phone 1 of the present illustrative embodiment includes a CPU 100, memory 200, a video encoder 301, an audio encoder 302, a key input circuit 303, a communication module 304, a backlight drive circuit 305, a video decoder 306, an audio decoder 307, a battery 309, and a power source section 310.

The camera module 15 has an imaging element, such as a CCD. The camera module 15 digitizes an imaging signal output from the imaging element, makes various corrections, such as gamma corrections, to the imaging signal, and outputs the thus-corrected signal to the video encoder 301. The video encoder 301 encodes the imaging signal from the camera module 15 and outputs the thus-encoded imaging signal to the CPU 100.

The microphone 35 converts the collected sound into an audio signal and outputs the audio signal to the audio encoder 302. The audio encoder 302 converts an analogue audio signal from the microphone 35 into a digital audio signal, subjects the digital audio signal to encoding, and outputs the thus-encoded digital audio signal to the CPU 100.

When each of the power key 36 and the hard keys 37 is pressed, the key input circuit 303 outputs an input signal corresponding to the pressed key to the CPU 100.

The communication module 304 converts the data from the CPU 100 into a radio signal and transits the radio signal to a base station by way of an antenna 304a. The communication module 304 converts the radio signal, which has been received by way of the antenna 304a, into data and outputs the data to the CPU 100.

The backlight drive circuit 305 supplies a drive signal, which is responsive to a control signal from the CPU 100, to the first panel backlight 11b, the first key backlight 13b, the second panel backlight 21b, and the second key backlight 23b. Each of the first panel backlight 11b, the first key backlight 13b, the second panel backlight 21b, and the second key backlight 23b is illuminated by a drive signal from the backlight drive circuit 305. The first panel backlight 11b illuminates the first liquid crystal panel 11a; the first key backlight 13b illuminates the first key cover 13a; the second panel backlight 21b illuminates the second liquid crystal panel 21a; and the second key backlight 23b illuminates the second key cover 23a.

The video decoder 306 converts the image data output from the CPU 100 into a video signal that can be displayed by the first liquid crystal panel 11a and the second liquid crystal panel 21a. The video signal is output to each of the first liquid crystal panel 11a and the second liquid crystal panel 21a. The first liquid crystal panel 11a displays an image corresponding to the video signal on the first display surface 11a1. The second liquid crystal panel 21a displays an image corresponding to the video signal on the second display surface 21a1.

The audio decoder 307 decodes the audio signal from the CPU 100 and sound signals of various annunciation sounds, such as a ring tone and an alarm sound, and converts the decoded audio and sound signals into analogue signals. Further, the analogue signals are output to the speaker 38. The speaker 38 reproduces an audio signal and a sound signal from the audio decoder 307.

The battery 309 is for supplying electric power to the CPU 100 and individual sections other than the CPU 100 and includes a secondary battery. The battery 309 is connected to the power source section 310.

The power source section 310 converts a voltage of the battery 309 into several voltages having magnitudes required for respective sections and supplies the voltages to the sections. The power source section 310 supplies the electric power, which has been supplied by way of an external power source (not shown), to the battery 309, thereby recharging the battery 309.

The memory 200 includes a ROM and a RAM.

A control program for implementing a control function to the CPU 100 is stored in the memory 200. Such a control program includes a control program that, when the application screen is enabled to be displayed on the combined display field 11a1-21a1 in a first display mode, displays the application screen on the first display surface 11a1 in a second display mode and also displays an image showing a predetermined function on the second display surface 21a1. In addition, various applications for implementing functions, such as a phone call, a mail, a web browser, and an image display, are stored in the memory 200.

The application screen is an example of an execution screen according to a user's input. The combined display field 11a1-21a1 is an example of a third display field which is regarded as one area as a result of the first display surface 11a1 and the second display surface 21a1 being combined. As will be described later, the first display mode is a display mode conforming to the combined display field. The second display mode is a display mode conforming to a single display field of each of the first display surface 11a1 and the second display surface 21a1.

The application also includes widgets. The widgets include a widget showing a content of a received mail; a widget showing a content written in response to SNS; widgets showing various pieces of information, like stock prices, news, and weather; a clock widget; a calendar widget; a dictionary widget; and a calculator widget. A widget has some of functions of the application and is linked to an application including all functions. For example, mail-related widgets include a widget displaying contents of the latest received mail, a history of the latest incoming calls, and the like. A widget having some of the functions is linked to an application having another function, such as a mail writing function and a return mail function.

Data, such as audio data, image data, and text data, are stored in a predetermined file format in the memory 200. The data include data pertaining to a photograph captured by the camera module 15, data input by the respective panel sensors 12 and 22, and data acquired from the outside by way of the communication module 304.

Information about images displayed on each of the display surfaces 11a1 and 21a1 is stored in the memory 200. The images displayed on the respective display surfaces 11a1 and 21a1 include graphics, such as icons, buttons, and photographs, and a text input in a text area, and others. Information about an image includes information about processing of the image, and positions on the respective display surfaces 11a1 and 21a1 where the images are displayed. Information about processing of an image, such as an icon and a button, includes information about a processing target, such as an application and a file, and details of processing, such as a startup and an exit.

Information about the first touch key and the second touch key is stored in the memory 200. Information about the first and second touch keys includes information about processing assigned to each of the key sensors 12 and 24 for detecting inputs made by the respective touch keys and processing assigned to the respective touch keys.

For example, when the first touch key K11 is pressed for a short period of time, information about processing for displaying the operation item screen on the first display surface 11a1 is assigned to such operation. When the first touch key K11 is pressed for a long period of time, information about processing for displaying a screen pertaining to a list of recently utilized applications on the first display surface 11a1 is assigned to such operation. When the second touch key K21 is pressed for a short period of time, information about processing for displaying an operation item screen on the second display surface 21a1 is assigned to such operation. Moreover, when the second touch key K21 is pressed for a long period of time, information about processing for displaying a list of recently utilized applications on the second display surface 21a1 is assigned to such operation. Icons depicting operation items are arranged on the operation item screen.

Information about processing for displaying, on the respective display surfaces 11a1 and 21a1, a setting screen which changes setting conditions of the mobile phone 1 is assigned to both the first touch key K12 and the second touch key K22. A list of a sound volume, screen brightness, and an active application is displayed on the setting screen.

The first touch key K13 and the second touch key K23 are assigned information about processing which goes back to previous processing by canceling processing which has been executed right before and processing for displaying, on the respective display surfaces 11a1 and 21a1, a screen of an application displayed right before.

In accordance with signals from the key input circuit 303, the respective panel sensors 12 and 22, and the key sensors 14 and 24, the CPU 100 activates the camera module 15, the microphone 35, the communication module 304, the respective liquid crystal panels 11a and 21a, the speaker 38, and the like, according to a control program. The CPU 100 thereby executes various applications, such as a communication application and a mail application.

The CPU 100 operates as an execution section, to thus execute processing according to an input made by the user. Specifically, when the user touches the respective display surfaces 11a1 and 21a1, the CPU 100 receives position signals corresponding to the input position from the respective panel sensors 12 and 22. The CPU 100 specifies an image displayed at the input position corresponding to the position signal and information about processing of the image. The CPU 100 reads an application or a file, which is a processing target, from the memory 200 in accordance with the thus-specified information about processing and lets the application execute the specifics of processing.

For example, when the user touches an icon A as shown in FIG. 4A, the CPU 100 reads, from the memory 200, an application A which is a processing target of the icon A and executes the thus-read application.

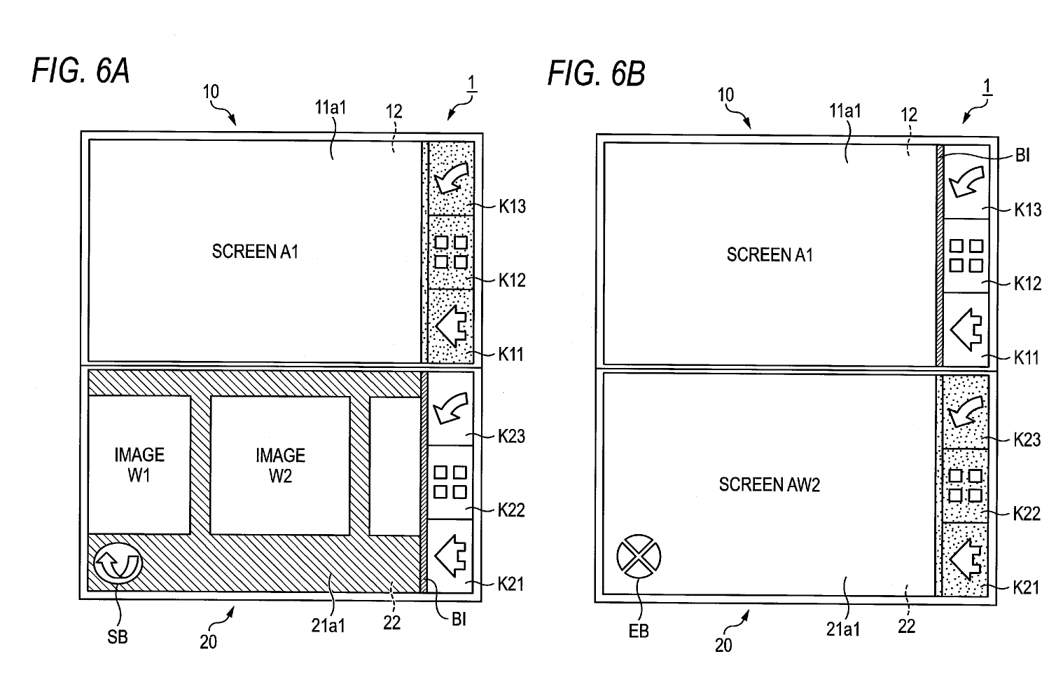

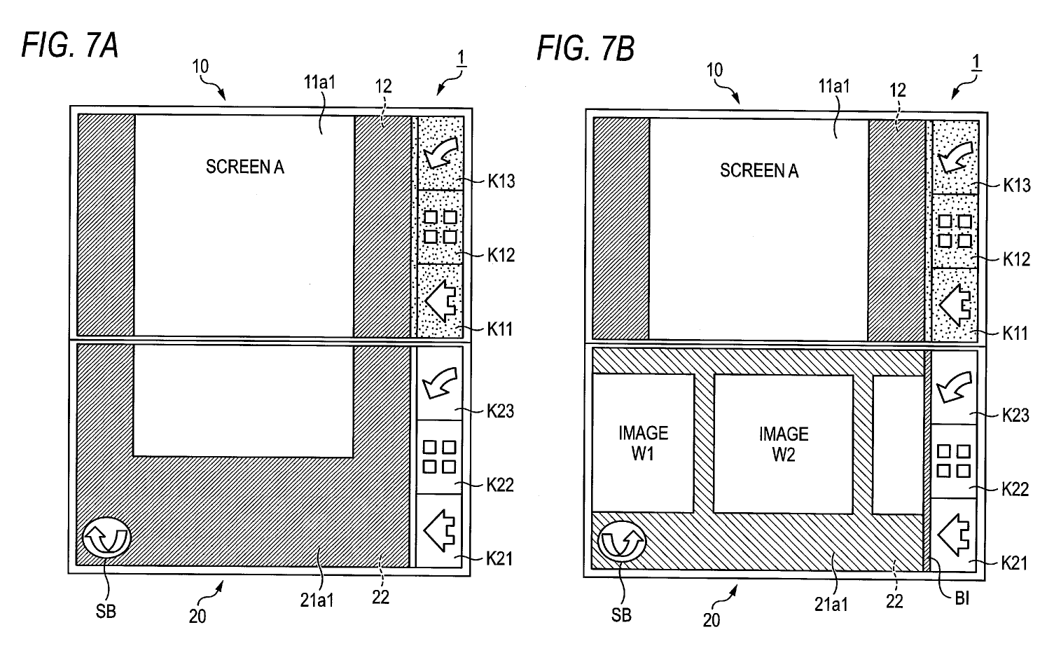

As shown in FIGS. 6A and 7B, when an image of a widget is touched from a widget list screen, which will be described later, the CPU 100 reads, from the memory 200, an application linked to the touched widget and executes the thus-read application.

When the user touches any of the key covers 13a and 23a, the CPU 100 receives a detection signal from each of the key sensors 14 and 24 and identifies the key sensors 14 and 24 having output the detection signal. The CPU 100 specifies a touch key detected by either the key sensor 14 or 24 and information about processing assigned to the respective touch keys 14 and 24 according to display information in the memory 200, and executes processing in accordance with the processing information.

For example, when the user touches the first touch key K11 shown in FIG. 4A for a short period of time, the CPU 100 reads image data pertaining to the operation item screen from the memory 200.

The CPU 100 operates as a determination section, to thus determine whether or not the screen of the application executed by the execution section is enabled to be displayed on the combined display field 11a1-21a1 in the first display mode.

The determination is made based on whether or not the application is set so as to switch a display size of the screen to conform to display standards, such as an image resolution, of the single display field or the combined display field 11a1-21a1. The first display mode is a mode of displaying an application screen while controlling the display size to conform to the display standards of the single display field. The second display mode is a mode of displaying the application screen by changing the display size to conform to the display standards of the combined display field 11a1-21a1.

The display size of the screen is changed by increasing or decreasing the display size of the screen or extracting a portion of the screen. For example, there is a case where the size of the application screen conforms to the display standards of the single display field and where the single display field differs from the combined display field 11a1-21a1 in terms of an aspect ratio. When such an application screen is displayed in the combined display field 11a1-21a1, a portion of the application screen is extracted to conform to the aspect ratio of the combined display field 11a1-21a1. Further, the thus-extracted portion of the application screen is enlarged, thereby changing the display size of the application screen to conform to the display standards of the combined display field 11a1-21a1.

For example, when application settings include information (hereinafter referred to as “combined display field support information”) indicating that an application screen is enabled to be displayed in the combined display field 11a1-21a1, the display size of the screen is changed to conform to the display standards of the single display field and the combined display field 11a1-21a1. Therefore, it is determined that the application screen is enabled to be displayed in the single display field in the second display mode and also displayed in the combined display field 11a1-21a1 in the first display mode.

In the meantime, when the application settings do not include the combined display field support information, display size of the screen conforms to the display standards of the single display field but does not conform to the display standards of the combined display field 11a1-21a1. For these reasons, the application screen is determined to be properly displayed in the single display field in the second display mode but not displayed in the combined display field 11a1-21a1 in the first display mode.

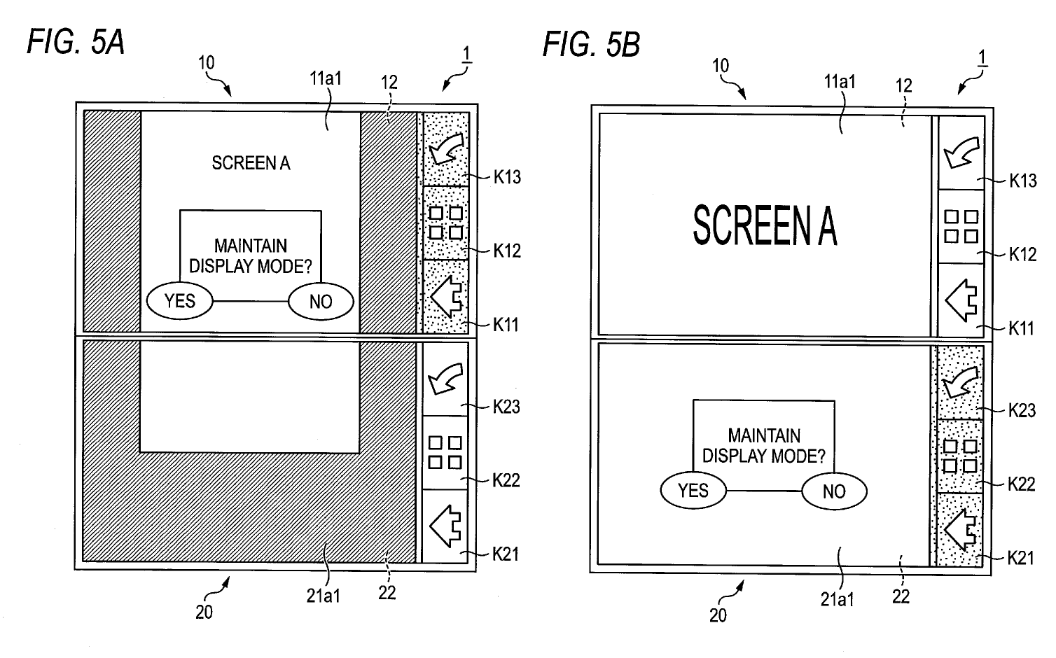

The application screen can be also displayed in the combined display field 11a1-21a1 in the second display mode. However, since the display size of the screen does not conform to the display standards of the combined display field 11a1-21a1, the screen is not properly displayed in the combined display field 11a1-21a1. When the display size of the application screen is not changed, the screen is displayed in a display size commensurate with the single display field and at a substantial center of the combined display field 11a1-21a1 as shown in FIG. 5A, and surroundings of the screen are displayed in black. Further, when the display size of the screen is increased, the screen is displayed in a stretched manner as shown in FIG. 5B, so that details of the application screen are not clearly displayed.

The CPU 100 outputs, as a display control section, control signals to the video decoder 306 and the backlight control circuit 305. For example, the CPU 100 controls the backlight drive circuit 305 and extinguishes the respective panel backlights 11b and 21b and the respective backlights 13b and 23b. In the meantime, the CPU 100 illuminates the respective panel backlights 11b and 21b and controls the video decoder 306, thereby displaying images on each of the display surfaces 11a1 and 21a1. Moreover, the CPU 100 illuminates the respective key backlights 13b and 23b. The CPU 100 also controls contrast, brightness, a screen size, and screen translucency that are employed when an image is displayed on each of the display surfaces 11a1 and 21a1.

For example, the CPU 100 displays, on each of the display surfaces 11a1 and 21a1, a screen of the application executed by the execution section in accordance with a user's operation. The application screen changes its display mode according to a state of the mobile phone 1.

In the closed state, the CPU 100 displays the application screen on the first display surface 11a1 in the second display mode as shown in FIG. 4B.

In the open state, the CPU 100 displays on each of the display surfaces 11a1 and 21a1 the application screen in the display mode conforming to a determination result made by the determination section.

Specifically, the determination section determines that the application screen is enabled to be displayed in the combined display field 11a1-21a1 in the first display mode. In this case, the CPU 100 adjusts the display size of the screen to conform to the display standards of the combined display field 11a1-21a1, thereby generating a screen, which is to be displayed in the combined display field 11a1-21a1, in a display memory area included in the memory 200. As shown in FIG. 4C, the application screen is displayed in the combined display field 11a1-21a1 in the first display mode. As mentioned above, the application screen is displayed over the entirety of the combined display field 11a1-21a1 such that contents to be displayed on the screen, such as graphics and texts, are clearly displayed in proper form without becoming distorted or blurred.

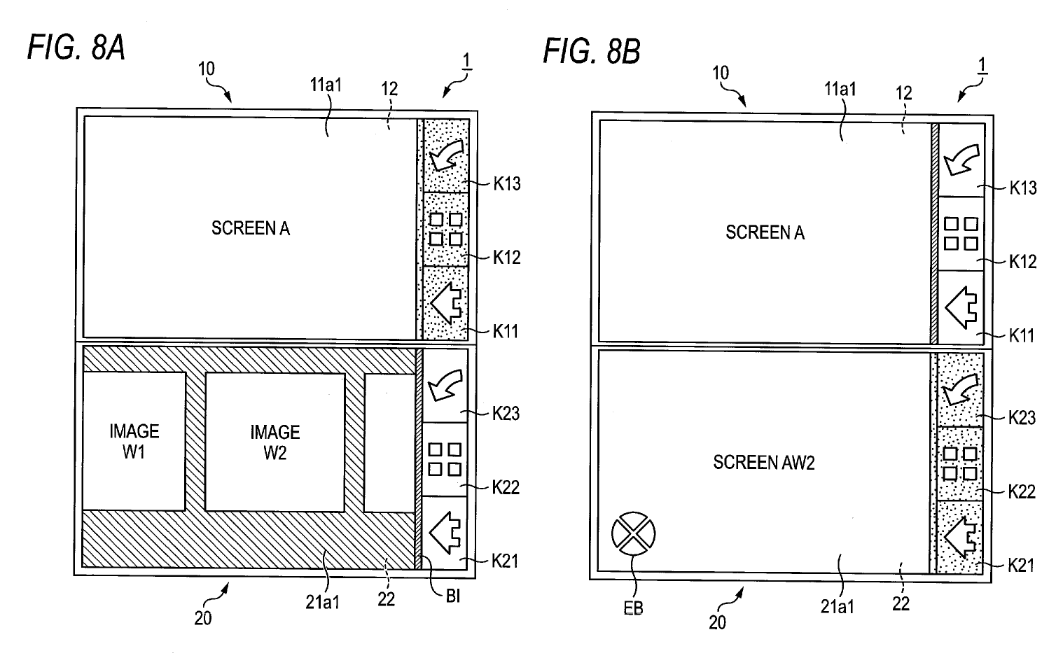

In the meantime, when the determination section determines that the application screen is not enabled to be displayed in the combined display field 11a1-21a1 in the first display mode, the CPU 100 displays the application screen on the first display surface 11a1 in the second display mode as shown in FIG. 8A, as well as displaying a screen including images showing predetermined functions on the second display surface 21a1. The screen including images showing predetermined functions includes an operation item screen displaying a list of icons and a screen showing a list of widgets. An image of a predetermined or arbitrary one widget or images of a plurality of predetermined or arbitrary widgets are displayed on the widget list screen. For example, images of widgets are displayed side by side on the widget list screen. When the user slides his/her finger sideways while touching a widget image, the widget image is displayed while being horizontally moved in accordance with an input position of the finger.

When different application screens or different processing screens are displayed respectively on the display surfaces 11a1 and 21a1, the CPU 100 displays a linear bar image BI along an edge of an active image which is a target of a user's operation as shown in FIG. 6A.

The CPU 100 illuminates the display surface or the touch key which is a target of a user's operation. Even when the user operates a touch key which is not illuminated, processing responding to operation is not performed.

### Procedures According to a First Illustrative Embodiment

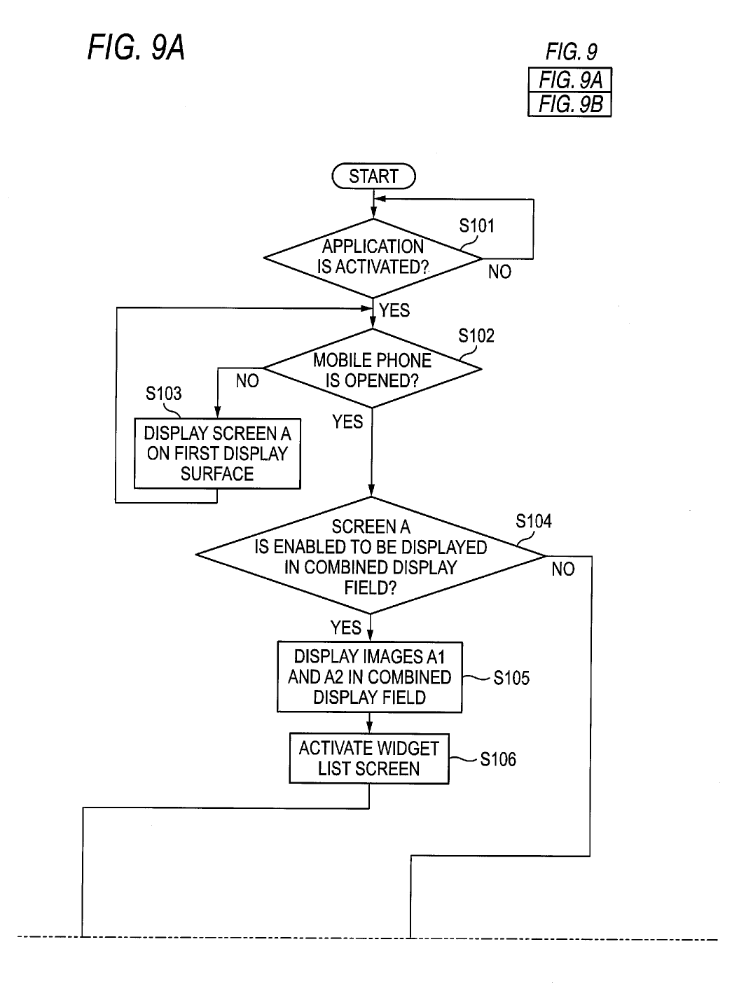

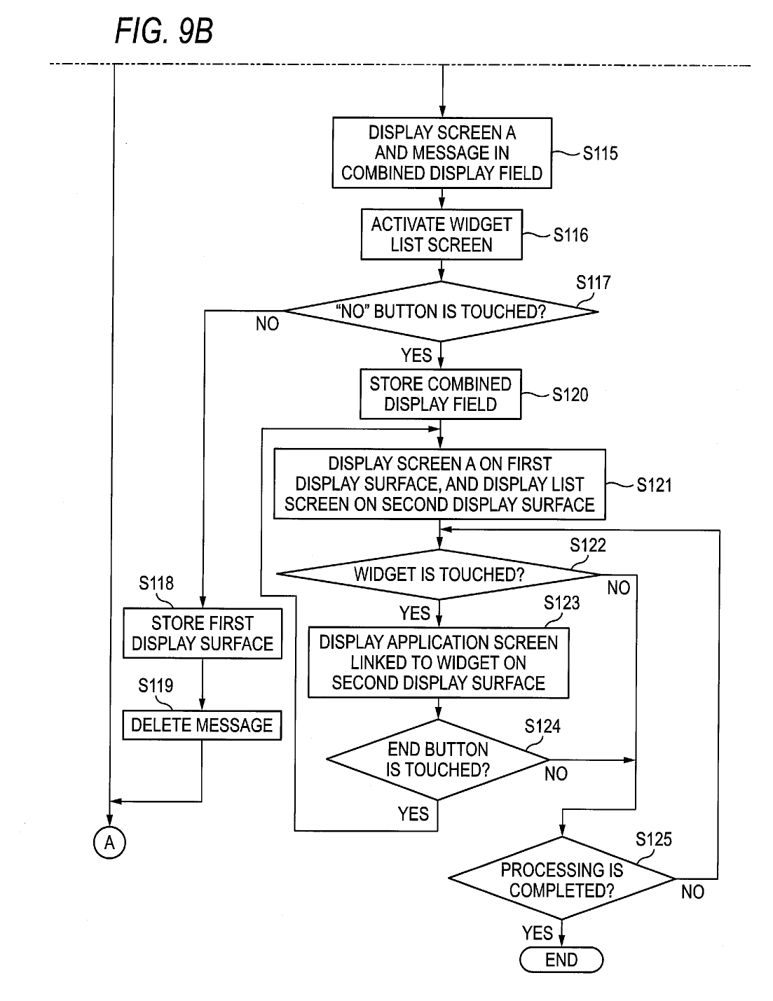

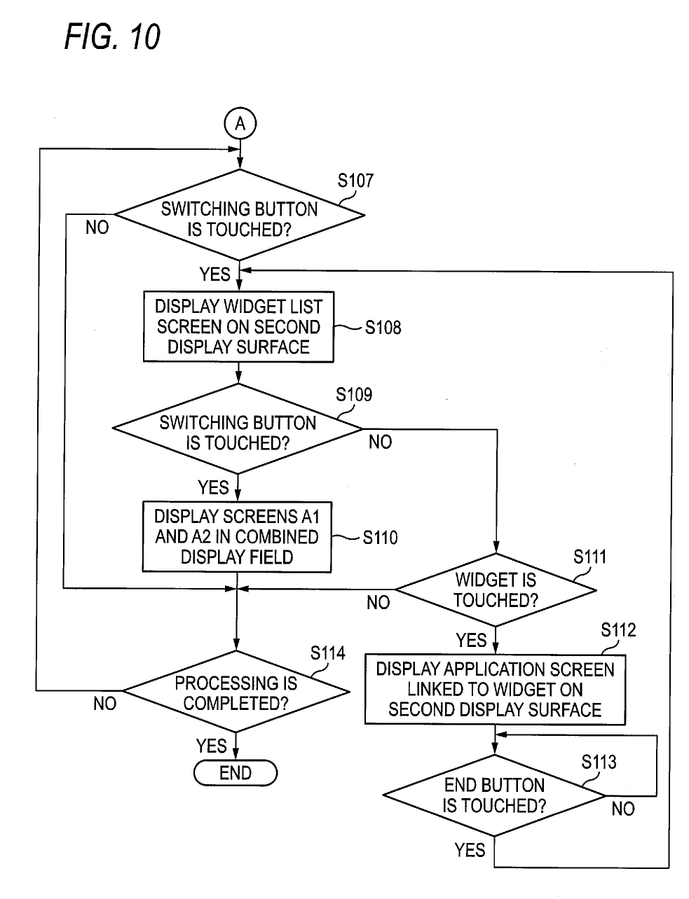

FIG. 4A is a drawing showing that the operation item screen is displayed on the first display surface 11a1 in the closed state. FIG. 4B is a drawing showing that a screen A of an application A is displayed on the first display surface 11a1 in the closed state. FIG. 4C is a drawing showing that screens A1 and A2 of the application A are displayed in the combined display field 11a1-21a1. FIGS. 5A and 5B are drawings showing that the screen A and a dialogue box of the application A are displayed in the combined display field 11a1-21a1. FIG. 6A is a drawing showing that a screen A1 of the application A is displayed on the first display surface 11a1 and that a widget list screen is displayed on the second display surface 21a1. FIG. 6B is a drawing showing that the screen A1 of the application A is displayed on the first display surface 11a1 and that a screen AW2 of the application linked to a widget is displayed on the second display surface 21a1. FIG. 7A is a drawing showing that the screen A of the application A is displayed in the combined display field 11a1-21a1. FIG. 7B is a drawing showing that the screen A of the application A is displayed on the first display surface 11a1 and that the widget list screen is displayed on the second display surface 21a1. FIG. 8A is a drawing showing that the screen A of the application A is displayed on the first display surface 11a1 and that the widget list screen is displayed on the second display surface 21a1. FIG. 8B is a drawing showing that the screen A of the application A is displayed on the first display surface 11a1 and that the screen AW2 of the application linked to the widget is displayed on the second display surface 21a1. FIGS. 9 and 10 are flowcharts showing procedures for displaying the application screen in the single display field or the combined display field 11a1-21a1 in accordance with a user's operation. Here, it is noted that the screen A1 and the screen A2 form a single screen A.

When operation for activating an application is performed in accordance with a user's operation, the CPU 100 performs processing for controlling a display of an application screen. During control processing, a display mode of the application screen in an open state is switched according to application settings or use's selection.

At first, it is monitored whether or not an application is activated by a user's operation (S101). For example, when the user touches an icon A on the operation item screen shown in FIG. 4A, an application A indicated by the icon A is activated (YES in S101).

Next, in order to specify the field where the screen A of the application A is displayed, the state of the mobile phone 1 is determined (S102).

When the mobile phone 1 is in a closed state (NO in S102), only the first display surface 11a1 remains exposed to outside. Therefore, as shown in FIG. 4B, the screen A of the application A is displayed on the first display surface 11a1 in the second display mode (S103).

In the meantime, when the mobile phone 1 is in an open state (YES in S102), the first display surface 11a1 and the second display surface 21a1 remain exposed to outside. Therefore, the screen A of the application A is displayed in the combined display field 11a1-21a1. Herein, the case where the mobile phone 1 is in the open state includes, a case where the mobile phone 1 is brought into the open state after the application A is activated in the closed state and the screen A is displayed on the first display surface 11a1 and a case where the application A is activated in the open state.

When the screen A of the application A is displayed on the combined display field 11a1-21a1, there is also a possibility that the screen A is not enabled to be displayed in the first display mode. In order to specify the possibility, it is determined whether or not the combined display field support information is included in settings of the application A. If the combined display field support information is included in the settings of the application A, it is determined that the screen A enabled to be displayed in the combined display field 11a1-21a1 in the first display mode (YES in S104). Consequently, for example, when the mobile phone 1 is switched from the closed state to the open state, the display mode of the application A is switched from the second display mode to the first display mode. As shown in FIG. 4C, the screens A1 and A2 making up the screen A are displayed in the combined display field 11a1-21a1 in the first display mode (S105).

While the screens A1 and A2 are displayed in the combined display field 11a1-21a1, an application showing the widget list screen is activated (S106). The application A is executed in a foreground, and the screens A1 and A2 are displayed in the combined display field 11a1-21a1. For these reasons, the application which displays the widget list screen is executed in a background, and the widget list screen is not displayed.

However, a switching button SB for switching between screens to be displayed on the second display surface 21a1 is displayed on the screen A2. When the switching button SB is touched (YES in S107), a widget list screen is displayed in place of the screen A2 on the second display surface 21a1 as shown in FIG. 6A (S108). The screen A1 remains displayed on the first display surface 11a1. Further, the switching button SB is displayed on the widget list screen on the second display surface 21a1.

When the switching button SB on the widget list screen is touched (YES in S109), the screen A2 is displayed in place of the widget list screen on the second display surface 21a1 as shown in FIG. 4C. Therefore, the screens A1 and A2 are displayed in the combined display field 11a1-21a1 (S110).

In the meantime, when the switching button SB is not touched and the image W2 of the widget W2 is touched in a state where the widget list screen shown in FIG. 6A is displayed (NO in S109 and YES in S111), the application AW2 linked to the widget W2 is activated. As shown in FIG. 6B, the screen AW2 of the application AW2 is displayed on the second display surface 21a1 (S112). Through the screen AW2 of the application AW2, the user can view information which is more detailed when compared with contents provided by the widget W2 and also perform operation according to the displayed contents.

An end button EB used for completing the application AW2 is displayed on the screen AW2 of the application AW2. When the end button EB is touched (YES in S113), the application AW2 ends, and the widget list screen shown in FIG. 6A is displayed in place of the screen AW2 on the second display surface 21a1 (S108).

Meanwhile, when neither the switching button SB nor the widget is touched (NO in S107 and NO in S110 and S111) and when the user performs operation for terminating the application A (YES in S114), processing is completed.

Further, if the settings of the application A does not include the combined display field support information, it is determined through processing pertaining to S104 that the screen A is not enabled to be displayed in the combined display field 11a1-21a1 in the first display mode (NO in S104). As shown in FIG. 5A, the screen A is displayed in the second display mode in the combined display field 11a1-21a1, and the dialogue box is arranged on the screen A (S115). A confirmation message “Do you maintain the display mode?,” a “YES” button, and a “NO” button are displayed in the dialogue box.

As mentioned above, the screen A is displayed in the combined display field 11a1-21a1, and an application for displaying a widget list screen is activated in the background (S116). In this case, since the screen A still remains displayed in the combined display field 11a1-21a1, the widget list screen is not displayed.

When any of the buttons in the dialogue box is touched, it is determined whether the “YES” button or the “NO” button is touched (S117). When the touched button is not the “NO” button; namely, the “YES” button (NO in S117), a display field assigned to the “YES” button is stored in the memory 200 (S118). Specifically, the user has selected maintenance of the state in which the screen A is displayed in the combined display field 11a1-21a1 in the second display mode in the open state. Consequently, the combined display field 11a1-21a1 is stored in the memory 200 in connection with the application A as a display field where the screen A is displayed in the second display mode in the open state. When the application A is activated next time, the screen A is displayed in the combined display field 11a1-21a1 stored in the memory 200 in the second display mode in the open state.

When the touched button is the “YES” button (NO in S117), the current display state is maintained. Therefore, although the screen A does not conform to the combined display field 11a1-21a1, the screen A is displayed in the combined display field 11a1-21a1 in the second display mode. As shown in FIG. 7A, the message is deleted (S119).

The switching button SB for switching between the screens to be displayed on the second display surface 21a1 is displayed on the second display surface 21a1. When the switching SB is touched (YES in S107), the widget list screen is displayed on the second display surface 21a1 as shown in FIG. 7B (S108). When the switching button SB on the widget list screen is touched (YES in S109), the screen A shown in FIG. 7A is displayed in place of the widget list screen on the second display surface 21a1 (S110). Further, when the image W2 of the widget W2 is touched on the widget list screen shown in FIG. 7B (NO in S109 and YES in S111), the screen AW2 of the application AW2 linked to the widget W2 is displayed on the second display surface 21a1 (S112). When an end button EB of the application AW2 is touched (YES in S113), the widget list screen is displayed on the second display surface 21a1 (S108). Further, when the user has performed operation for completing the application A (YES in S114) without touching the switching button SB and the widget (NO in S107 and NO in S110 and S111), processing ends.

When the “NO” button is touched (YES in S117), the user selects, during processing pertaining to S117, not to maintain a display state in which the screen A of the application A is displayed in the combined display field 11a1-21a1 in the second display mode. Therefore, the single display field; namely, the first display surface 11a1 or the second display surface 21a1, is stored, in connection with the application A, in the memory 200 as a display field for displaying the screen A in the second display mode in the open state (S120).

As shown FIG. 8A, the screen A is displayed on the first display surface 11a1, and the widget list screen is displayed on the second display surface 21a1 (S121). When the image W2 of the widget W2 is touched on the widget list screen (YES in S122), the screen AW2 of the application AW2 linked to the widget W2 is displayed on the second display surface 21a1 as shown in FIG. 8B (S123). When the end button EB on the screen AW2 is touched (YES in S124), the widget list screen shown in FIG. 8A is displayed in place of the screen AW2 on the second display surface 21a1 (S121). In the meantime, when neither the widget nor the end button EB is touched (NO in S122 and NO in S124) and when operation for completing the application A is performed (YES in S125), processing is completed.

In the present illustrative embodiment, when the application screen is not enabled to be displayed in the combined display field 11a1-21a1 in the first display mode, the application screen is displayed once in the second display mode in the combined display field 11a1-21a1. Accordingly, after viewing the state of the displayed screen, the user can select whether to display the application screen in the combined display field 11a1-21a1 in the second display mode or display the application screen in the single display field. The display field of the application screen can thus be changed according to a user's intension.

In the present illustrative embodiment, when the user makes such a selection as to display an application screen, which is not enabled to be displayed in the first display mode, in the single display field, the application screen is displayed on the first display surface 11a1 in the second display mode. Further, the widget list screen is displayed on the second display surface 21a1. As mentioned above, the second display surface 21a1 does not become useless, and the display surface can be effectively utilized.

Further, images of widgets showing predetermined functions are displayed on the widget list screen. Therefore, the user can check information represented by the widget images without activating the application, so that user convenience is improved.

Further, when the application screen is displayed in the combined display field 11a1-21a1 in the first display mode or when the user makes a selection such that the application screen is displayed in the combined display field 11a1-21a1 in the second display mode, the application screen is displayed in the combined display field 11a1-21a1. Even in such a case, when the mobile phone 1 comes into an open state, the application in the widget list screen is activated. Therefore, the user can display the widget list screen by the switching button SB without termination of the application, so that user convenience is improved.

### Another Illustrative Embodiment

Although the illustrative embodiment of the present invention has been described above, the present invention is not limited by the illustrative embodiment. Moreover, the illustrative embodiment of the present invention is also susceptible to various modifications.

For example, the present illustrative embodiment is configured such that, when the application screen does not support the combined display field 11a1-21a1, the user is allowed to select a display mode after the application screen and the message are displayed in the combined display field 11a1-21a1. In contrast to this, the application screen can also be automatically displayed on the first display surface 11a1 and the second display surface 21a1.

Further, in the illustrative embodiment, when the application screen that does not support the combined display field 11a1-21a1 is selected to be displayed in the single display field, the application screen is displayed on the first display surface 11a1, and the widget list screen is displayed on the second display surface 21a1. However, the application screen can also be displayed on the second display surface 21a1, and the widget list screen can be displayed on the first display surface 11a1.

In the illustrative embodiment, when the switching button SB is touched, the widget list screen is displayed on the second display surface 21a1. However, the widget list screen can also be displayed on the first display surface 11a1.

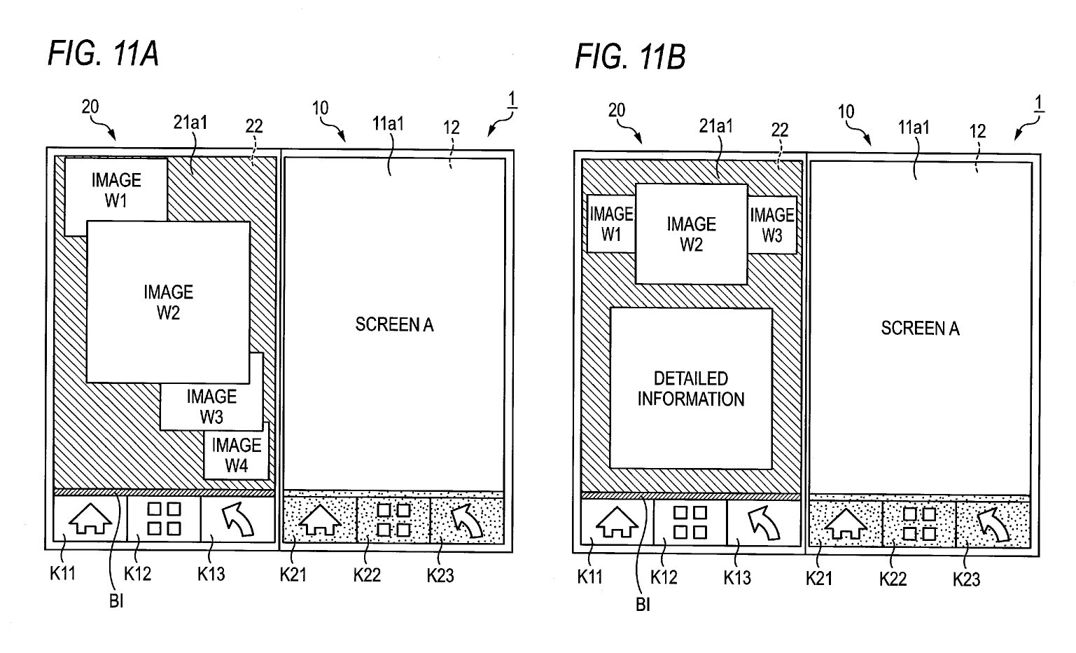

In the above illustrative embodiment, when the mobile phone 1 is horizontally laid, the widget images are arranged side by side in a landscape orientation on the widget list screen as shown in FIGS. 6A, 7B, and 8A. By contrast, when the mobile phone 1 is oriented in the vertical direction, the widget images can also be obliquely arranged side by side on the widget list screen as shown in FIG. 11A. When the user slides his/her finger in an oblique direction while touching any of the widget images, a display position of the widget image obliquely moves. Moreover, information about details of a widget image displayed at a substantial center of the widget list screen can also be displayed as shown in FIG. 11B.

Further, in the illustrative embodiment, when the mobile phone 1 is switched from the closed state to the open state, the application screen is displayed on the first display surface 11a1, and the widget list screen is displayed on the second display surface 21a1. At this time, settings can also be made such that any of the screens can be made active. For example, an active screen can also be set as the screen in accordance with an application displayed on the first display surface 11a1. When an application is a game or a motion picture, the application screen is set in an active state. If the application is a mail or browser application, the widget list screen will be set to an active state.

Although the mobile phone 1 is described as a portable terminal apparatus in the illustrative embodiment, a portable terminal apparatus such as a PDA and a portable gaming machine, can also be used.

In addition, the present illustrative embodiment of the present invention is appropriately susceptible to various modifications within a range of technical ideas disclosed in claims. For example, some or all of the illustrative embodiments can be combined together.

What is claimed is:

1. A portable terminal apparatus comprising:
a first display section;
a second display section;
a first cabinet having the first display section;
a second cabinet having the second display section;
a mechanism section joining the first cabinet to the second cabinet to allow switching between a first state where the first display section is exposed to outside and a second state where the first display section and at least a portion of the second display section are exposed to outside;
a first detection section configured to detect an input to the first display section;
a second detection section configured to detect an input to the second display section;
a display control section configured to control a display of the first display section and a display of the second display section; and
a determination section configured to determine whether, in the second state, an execution screen corresponding to an input detected by any one of the first detection section and the second detection section is enabled to be displayed on a third display field in a first display mode conforming to the third display field, the third display field being a combination of a first display field of the first display section and a second display field of the second display section to be regarded as a single display field,
wherein if the determination section determines that the execution screen is not enabled to be displayed on the third display field in the first display mode, the display control section is configured to display the execution screen on one of the first and second display fields in a second display mode confirming to the one of the first and second display fields.

2. The portable terminal apparatus according to claim 1,
wherein the display control section is configured to display an image representing a predetermined function on the other one of the first and second display fields in addition to displaying the execution screen on the one of the first and second display fields.

3. The portable terminal apparatus according to claim 1,
wherein if the determination section determines that the execution screen is not enabled to be displayed on the third displayed field in the first mode, the display control section is configured to display a confirmation screen to confirm whether to display the execution screen in the second mode, and
wherein if an input of switching a display field for displaying the execution screen from the third display field into the one of the first and second display fields is detected by any one of the first detection second and the second detection section, the display control section is configured to display the execution screen on the one of the first and second display fields.

4. The portable terminal apparatus according to claim 3,
wherein the display control section is configured to display an image representing a predetermined function on the other one of the first and second display fields in addition to displaying the execution screen on the one of the first and second display fields.

5. The portable terminal apparatus according to claim 3, further comprising:
a storage section,
wherein if the input of switching the display field for displaying the execution screen from the third display field to the one of the first and second display fields is detected, the storage section is configured to store information indicating that the one of the first and second display fields is a display field where the execution screen is displayed in the second display mode.

6. The portable terminal apparatus according to claim 1,
wherein if the determination section determines that the execution screen is enabled to be displayed in the third display field in the first display mode, the display control section is configured to display the execution screen on the third display field in the first display mode.

7. The portable terminal apparatus according to claim 2, further comprising:
an execution section configured to execute the function represented by the image,
wherein when any one of the first detection section and the second detection section detects an input for selecting the image, the execution section is configured to execute the function represented by the selected image.

8. The portable terminal apparatus according to claim 1, further comprising:
an execution section configured to execute an application,
wherein the display control section is configured to display the execution screen based on the application executed by the execution section, and
wherein determination section is configured to determined whether the execution screen is enabled to be displayed on the third display field in the first mode based on a setting of the application being executed.

9. A non-transitory computer readable medium having a computer program stored thereon and readable by a computer of a mobile terminal apparatus including a first display section, a second display section, a first cabinet having the first display section, a second cabinet having the second display section, a mechanism section joining the first cabinet to the second cabinet to allow switching between a first state where the first display section is exposed to outside and a second state where the first display section and at least a portion of the second display section are exposed to outside, a first detection section configured to detect an input to the first display section, and a second detection section configured to detect an input to the second display section, the computer program, when executed by the computer, causing the computer to perform operations comprising:
determining whether, in the second state, an execution screen corresponding to an input detected by any one of the first detection section and the second detection section is enabled to be displayed on a third display field in a first display mode conforming to the third display field, the third display field being a combination of a first display field of the first display section and a second display field of the second display section to be regarded as a single display field; and
if it is determined that the execution screen is not enabled to be displayed on the third display field in the first display mode, displaying the execution screen on one of the first and second display fields in a second display mode conforming to the one of the first and second display fields.

10. A display method for a mobile terminal apparatus including a first display section, a second display section, a first cabinet having the first display section, a second cabinet having the second display section, a mechanism section joining the first cabinet to the second cabinet to allow switching between a first state where the first display section is exposed to outside and a second state where the first display section and at least a portion of the second display section are exposed to outside, a first detection section configured to detect an input to the first display section, and a second detection section configured to detect an input to the second display section, the display method comprising:
determining whether, in the second state, an execution screen corresponding to an input detected by any one of the first detection section and the second detection section is enabled to be displayed on a third display field in a first display mode conforming to the third display field, the third display field being a combination of a first display field of the first display section and a second display field of the second display section to be regarded as a single display field; and
if it is determined that the execution screen is not enabled to be displayed on the third display field in the first display mode, displaying the execution screen on one of the first and second display fields in a second display mode conforming to the one of the first and second display fields.
